(19) United States
(12) Patent Application Publication
(10) Pub. No.: US 2024/0410615 A1
(43) Pub. Date: Dec. 12, 2024

(54) BASEBOARD VENT ASSEMBLY AND METHOD OF USE

(71) Applicant: Filtrex Pure Air, LLC, Boardman, OH (US)

(72) Inventor: Dominic Pecchia, Youngstown, OH (US)

(73) Assignee: Filtrex Pure Air, LLC, Boardman, OH (US)

(21) Appl. No.: 18/330,864

(22) Filed: Jun. 7, 2023

(51) Int. Cl. F24F 13/08; B01D 46/00; B01D 46/16

(52) U.S. Cl. CPC F24F 13/085; B01D 46/0028; B01D 46/16; B01D 2279/50; B01D 2279/65

(57) ABSTRACT

A filtered air vent apparatus has a vent housing body comprising a first sidewall and a second sidewall defining a portion of an air passageway that extends between at least a first open end and a second open end. There is a grill hingedly attachable to the vent housing body and securable to the vent housing body. A dual-mode filter support is sized to fit within the vent housing body in the air passageway. A filter is selectively and removably positioned on the dual-mode filter support behind the grill and in the air passageway. The dual-mode filter support is selectively movable between the first mode and the second mode.

### TECHNICAL FIELD

This disclosure is directed generally to filtered vent registers.

### BACKGROUND ART

Duct end filtered vent registers are known to exist. These filtered vent registers are designed to filter the air coming through a vent register in a building or HVAC system. Currently, there are different types of filtered vent registers.

Standard register with filter: This type of vent register is similar to a standard vent register, but it includes a filter that is placed at the end of the duct. The filter is designed to capture airborne particles such as dust, pollen, and pet dander.

Hinged filter register: This type of vent register includes a hinged filter that can be easily opened and closed for filter replacement. The filter is placed at the end of the duct, and the hinged cover allows easy access for filter changes. One exemplary hinged filter register is taught in U.S. Pat. No. 6,942,710.

Side loading filter register: This type of vent register includes a filter that is loaded from the side of the register rather than the end. This allows for easy filter replacement without having to remove the entire vent register from the wall or ceiling.

Disposable filter register: This type of vent register includes a disposable filter that is designed to be replaced on a regular basis. The filter is typically made of a disposable material such as fiberglass or polyester, and it can be easily replaced when it becomes clogged with airborne particles.

Permanent filter register: This type of vent register includes a permanent filter that is designed to last for the life of the register. The filter is typically made of a washable material such as foam or mesh, and it can be easily cleaned and reused.

Overall, duct end filtered vent registers are an important component of HVAC systems that help to improve indoor air quality by capturing airborne particles before they are circulated through the building. The specific type of vent register used will depend on the specific needs of the building or HVAC system.

### SUMMARY OF THE INVENTION

Although the foregoing types of filtered vent registered are known, there is still room for improvement. For example, with respect to hinged registers with a filter, there is a need to improve their manufacture by providing more capabilities and functionality. For example, some users like the availability to selectively choose whether to have the register or vent be open or closed. The present disclosure addresses this need in a hinged filter register by providing a dual-mode filter support that will allow the user to selectively choose whether to permit or preclude air flow through the vent or register by moving, rotating, inverting or flipping the dual-mode filter support between a first position or first mode (i.e., to permit airflow) and a second position or second mode (to substantially preclude or impede airflow).

In one aspect, an exemplary embodiment of the present disclosure may provide a filtered air vent apparatus comprising: a vent housing body comprising a first sidewall and a second sidewall defining a portion of an air passageway that extends between at least a first open end and a second open end; a grill hingedly attachable to the vent housing body and securable to the vent housing body in a snap fit configuration; a dual-mode filter support sized to fit within the air passageway; and a filter that is selectively and removably positioned on the dual-mode filter support behind the grill and in the air passageway.

In another aspect, an exemplary embodiment of the present disclosure may provide a method for a filtered air vent apparatus comprising: moving a grill from a first position to a second position relative to a vent housing body that defines an air passageway therethrough; placing a dual-mode filter support within the vent housing body, wherein the dual mode-filter support is an elongated L-shaped member that includes a first leg, wherein at least one aperture is formed in the first leg, and includes a second leg, wherein the second leg is solid; and moving the grill from the second position to the first position.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is an environmental perspective view of a filtered air vent apparatus according to one aspect of the present disclosure, the filtered air vent apparatus shown mounted on a wall at the terminal opening of an air duct (not shown).

FIG. 2 is an exploded perspective view of the filtered air vent apparatus of FIG. 1.

FIG. 3 is a front perspective view of a vent housing body of the filtered air vent apparatus.

FIG. 4A is a front elevation view of the vent housing body of the filtered air vent apparatus.

FIG. 4B is a rear elevation view of the vent housing body of the filtered air vent apparatus.

FIG. 4C is a top plan view of the vent housing body of the filtered air vent apparatus.

FIG. 5 is a front perspective view of a grill of the filtered air vent apparatus.

FIG. 6A is a front elevation view of the grill of the filtered air vent apparatus.

FIG. 6B is a rear elevation view of the grill of the filtered air vent apparatus.

FIG. 7 is a front perspective view of a dual-mode filter support of the filtered air vent apparatus.

FIG. 8 is a top plan view of the dual-mode filter support of the filtered air vent apparatus.

FIG. 9A is an operational front perspective view of connecting the grill to the vent housing body and moving the grill from an open or first position toward a closed or second position.

FIG. 9B is a transverse cross section view of the filtered air vent apparatus with the dual-mode filter support oriented in a first mode to permit air to move through an air passageway.

FIG. 9C is a transverse cross section view of the filtered air vent apparatus with the dual-mode filter support oriented in a second mode to preclude or impede air from moving through the air passageway.

Similar numbers refer to similar parts throughout the drawings.

### DETAILED DESCRIPTION

A vent register or a filtered air vent apparatus is shown throughout the figures as register or apparatus 10. Apparatus 10 is configured to be mounted on a wall 12 or floor of a structure, such as a building or home, and align with an air duct 14 or air return duct, which may be in the wall 12 or in the floor.

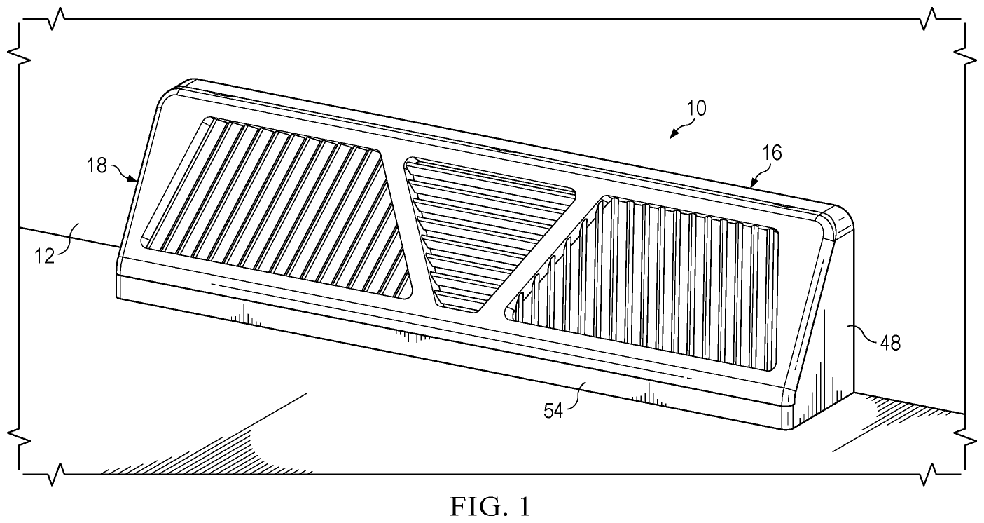

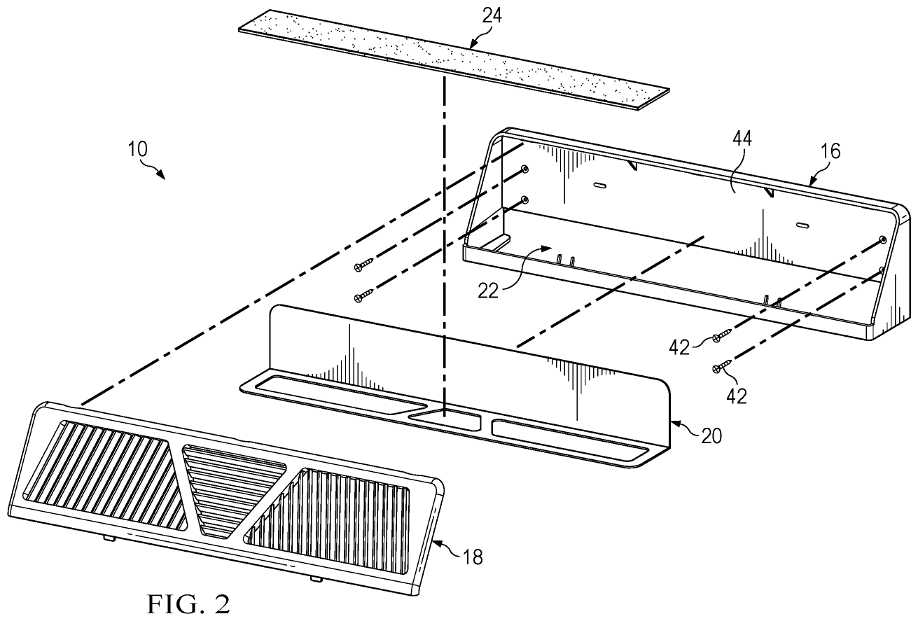

FIG. 1 and FIG. 2 depict one exemplary embodiment of the apparatus 10 that includes a vent housing body 16, a louvered grill 18 hingedly attachable to the vent housing body 16 and securable to the vent housing body 16 in a snap fit configuration, a dual-mode filter support 20 sized to fit within an air passageway 22 defined by the vent housing body 16, and a filter 24 that is selectively and removably positioned on the dual-mode filter support 20 behind the grill 18 and in the air passageway 22.

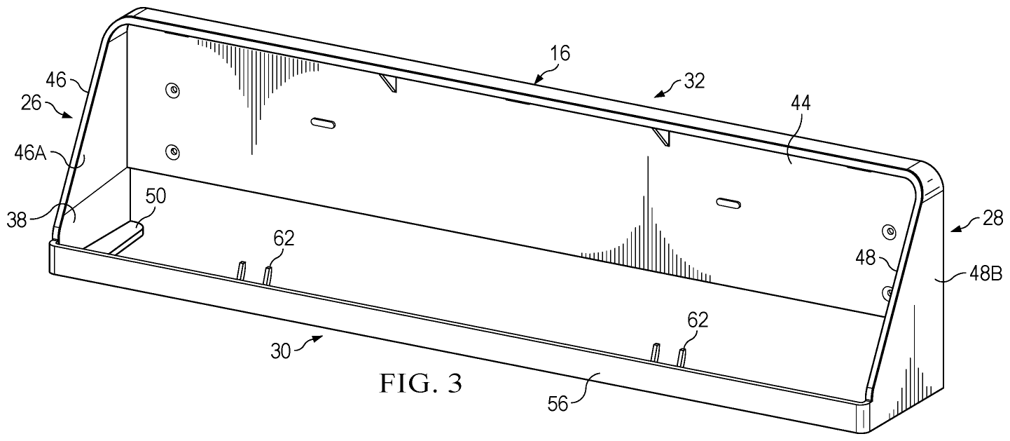

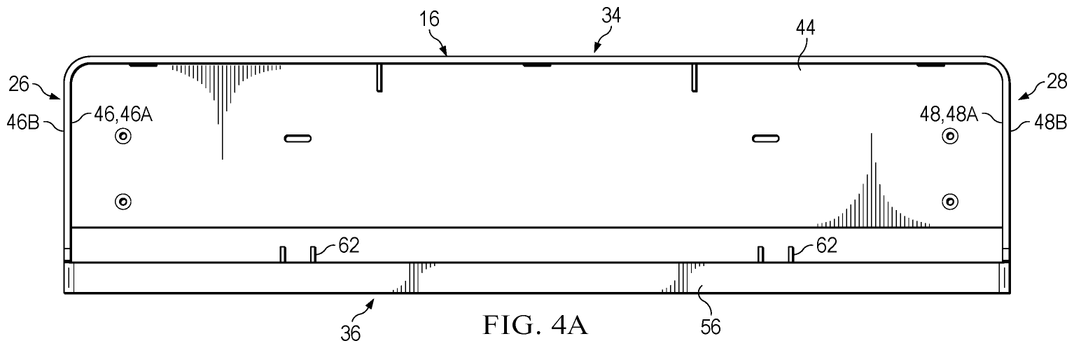

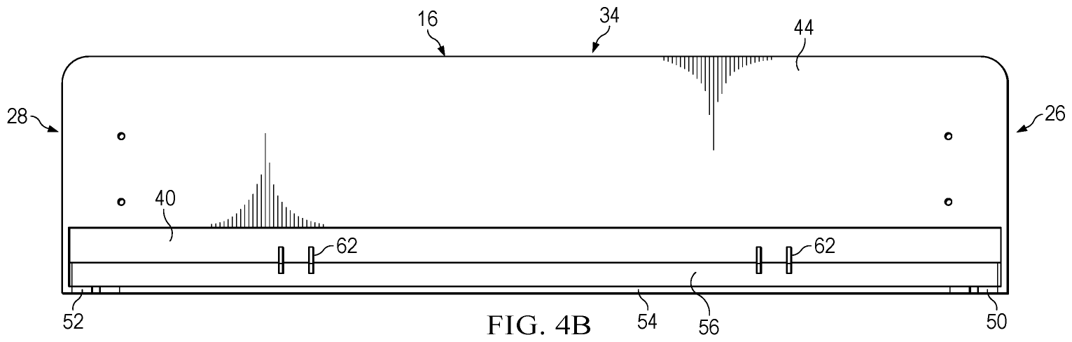

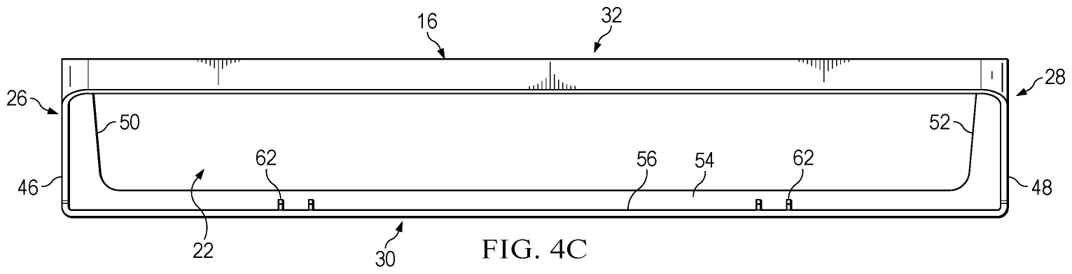

FIG. 2 through FIG. 4C depict that the vent housing body 16 may include a first side 26 opposite a second side 28 defining a longitudinal direction therebetween. The housing body 16 includes a front end 30 and a rear end 32 defining a transverse direction therebetween. The housing body includes a top or upper end 34 opposite a bottom or lower end 36 defining a vertical direction therebetween. The housing body 16 defines the air passageway 22 that extends between at least a first open end 38 near the front end 30 and a second open end 40 near the rear end 32 and bottom 36 of the housing body 16. The rear end 32 of the housing body 16 mounts to the wall 12 of the structure via fasteners 42 that extend transversely through wall 44. Wall 44 lies flush against wall 12. When mounted, the air passageway 22 aligns with the air duct 14.

The housing body 16 may be formed as a unibody monolithic member, however the body could also be formed as distinct components that are connected together. The body 16 may be a unibody that is integrally extruded, molded, printed, or additively manufactured, removably machined, or formed as a unitary, monolithic member substantially fabricated from a rigid, manmade, material. In one example, the body 16 may be formed from a generally rigid polymer material that withstands deformation in operation as a vent register. In one example, metal or metal alloys, such as stainless steel or aluminum alloy, may form a substantial majority of the components or elements used to fabricate the body 16 and the various components integrally formed, molded, or extruded therewith. While it is contemplated that the body 16 and its additional components described herein are uniformly and integrally extruded, molded, or formed, it is entirely possible that the components of the housing body be formed separately from alternative materials as one having routine skill in the art would understand. Furthermore, while the components of the body 16 are discussed below individually, it is to be clearly understood that the components and their corresponding reference elements of the body 16 are portions, regions, or surfaces of the body and all form a respective element or component of the unitary body 16. Thus, while the components may be discussed individually and identified relative to other elements or components of the housing body, in this exemplary embodiment, there is a single body 16 having the below described portions, regions, or surfaces.

Housing body 16 includes a first sidewall 46 and a second sidewall 48. The first and second sidewalls 46, 48 define a portion of the air passageway. The rear wall 44 extends longitudinally between the first and second sidewalls 46, 48. The first and second sidewalls are generally triangular in configuration, namely in the general shape of a right angle triangle. The first sidewall 46 includes an inner surface 46A and an outer surface 46B. The second sidewall 48 includes an inner surface 48A and an outer surface 48B. The inner surfaces 46A, 48A face each other.

The inner surface 46A of the first sidewall 46 has an upper end and a lower end. A first lip 50 is connected to or on the first sidewall 46 of the vent housing body. In one embodiment, the first lip 50 extends inwardly into the air passageway 22. The first lip 50 may be connected at or near the lower end of the inner surface 46A of the first sidewall 46. In one embodiment, the first lip 46 is cantilevered inwardly into the air passageway 22 from the inner surface 46A of the first sidewall 46. In one embodiment, the first lip 50 is flat and oriented parallel to the transverse direction or a horizontal plane.

The inner surface 48A of the second sidewall 48 has an upper end and a lower end. A second lip 52 is connected to or on the second sidewall 48 of the vent housing body 16. In one embodiment, the second lip 52 extends inwardly into the air passageway 22. The second lip 52 may be connected at or near the lower end of the inner surface 48A of the second sidewall 48. In one embodiment, the second lip 52 is cantilevered into the air passageway 22 from the inner surface 48A of the second sidewall 48. In one embodiment, the second lip 52 is flat and oriented parallel to the transverse direction or a horizontal plane.

In another embodiment, the first lip 50 and the second lip 52 are connected via a longitudinal front lip 54 that extends longitudinally between the first sidewall 46 and second sidewall 48. The front lip 54 may extend inward into the air passageway 22 in a cantilevered manner from the lower front wall 56. In one embodiment, the second lip 52 is flat and oriented parallel to a horizontal plane. As will be described in greater detail herein the first lip 50, the second lip 52, and the front lip 54, which collectively define a U-shaped lip are configured to receive the dual-mode filter support 20 thereon in at least two different modes of operations. Stated otherwise, regardless of which mode of operations the filter support 20 is used, the lip (or collective lips 52, 54, 56) support the filter support 20.

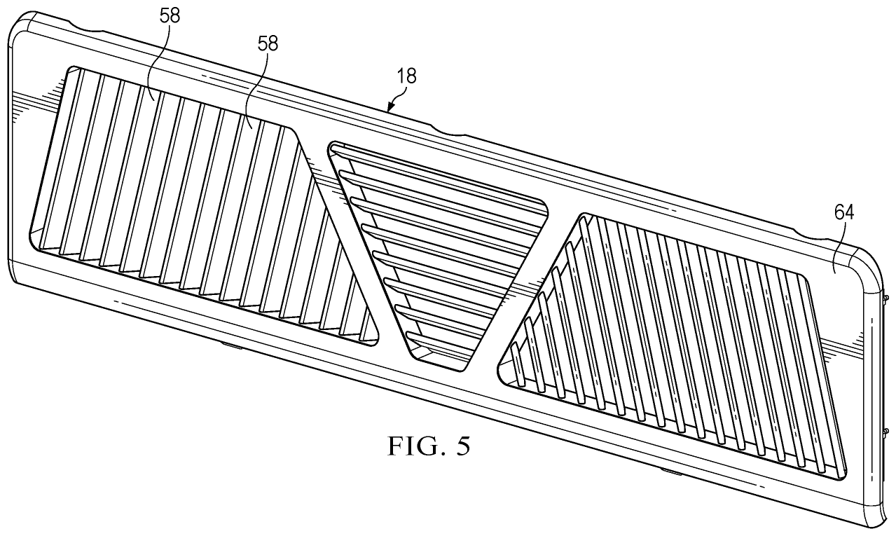

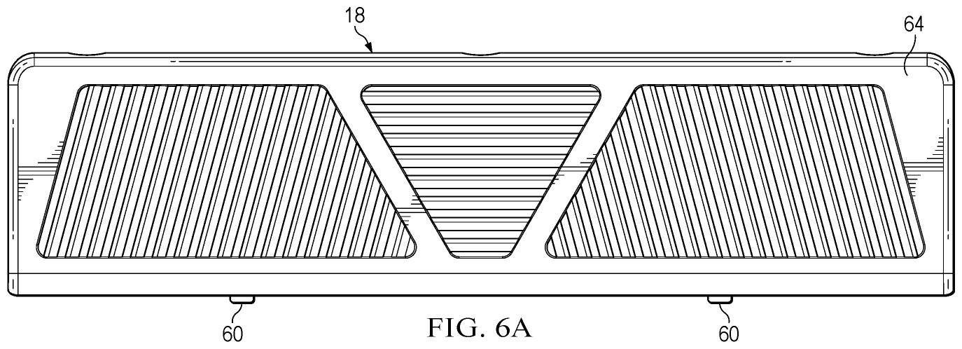

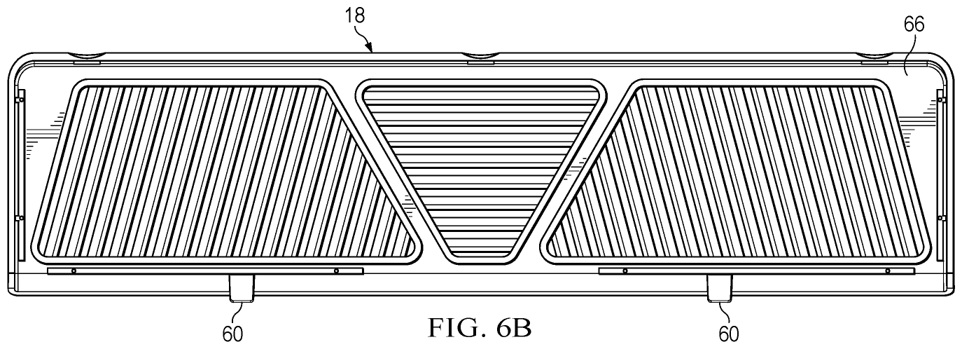

FIG. 2 and FIG. 5.-FIG. 6B depict that the grill 18 is a louvered grill having louvers 58 or slats that define openings therebetween that are in fluid communication with air passageway 22. Grill 18 pivotably or hingedly attaches to the vent housing body 16 via hinge flanges 60 which are accepted by the corresponding hinge notches 62 on the vent housing body. The grill 18 includes a front surface 64 and a rear surface 66. When apparatus 10 is assembled, the rear surface 66 of the grill 18 is spaced apart from the filter 24. The rear surface 66 of the grill is free of or otherwise does not include any feature or element that retains or touches the filter 24. Stated otherwise, there is no bezel on the rear surface 66 of the grill 18 such as what was previously taught in U.S. Pat. No. 6,942,710. Stated otherwise, the filter 24 is independent from the grill 18 and the two can move independently of each other. For example, because the filter 24 is not connected to the grill 18, the filter 24 is able to remain stationary within the air passageway 22 when the grill is selectively moved between a first position and a second position by pivoting the grill 18 relative to body 16 via the hinges. When the grill 18 is moved to the closed second positon, the grill 18 is then selectively attached affixed to the vent housing bod 16y by snap-fit or frictional-interference fit flanges or components.

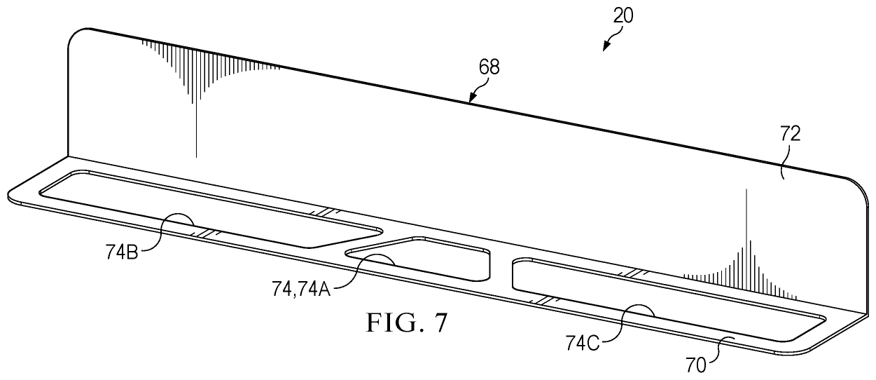

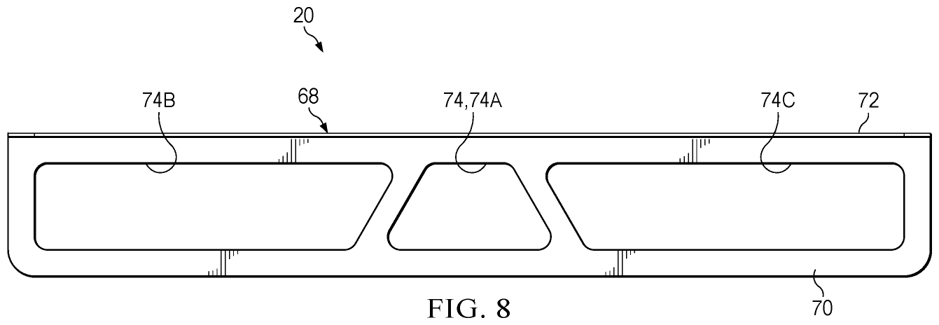

FIG. 2, FIG. 7, and FIG. 8 depict that the dual-mode filter support 20 is sized to fit within the air passageway 22 includes a body 68. The body 68 of the dual-mode filter support 20 may be formed as a monolithic unibody elongated L-shaped member. Or, it may be formed an elongated L-shaped member comprising distinct components that are connected together. Body 68 may be either metal or plastic. The body 68 of the dual-mode filter support 20 includes a first leg 70 of the L-shaped elongated member, wherein at least one aperture 74 is formed in the first leg 70 that permits air to flow through the aperture 74 in the first leg 70. A second leg 72 of the elongated L-shaped member may be solid (i.e., without any holes) to substantially impeded, preclude or prevent any air to flow through the second leg 72. First leg 70 may be orthogonal to second leg 72. In one embodiment, the at least one aperture 74 is one of three apertures. Namely, there may be a first aperture 74A, a second aperture 74B, and a third aperture 74C. The first aperture 74A may be formed centrally in the first leg 70 between the second aperture 74B and the third aperture 74C. The first aperture 74A may be shaped as a quadrilateral. More particularly, the first aperture may be shaped as an isosceles trapezoid having rounded corners. The second aperture 74B and third aperture 74C may also be shaped as quadrilaterals, respectively. More particularly, the second aperture 74B and the third aperture 74C may be each be shaped as a trapezoid with rounded corners. Although the at least one aperture 74 can take on any configuration or shape, it has been determine some embodiments of the present disclosure benefit from the configurations shown herein to maximize airflow through the first leg 70. Notwithstanding the foregoing, the apertures 74A-74C can be circular, triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

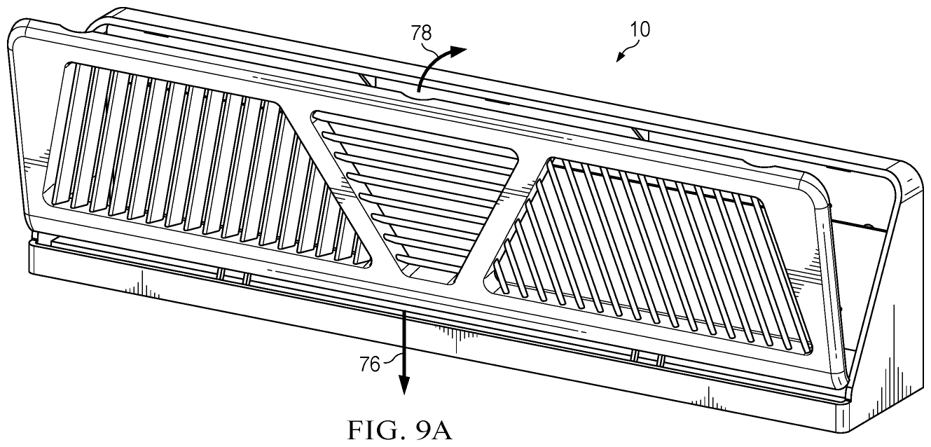

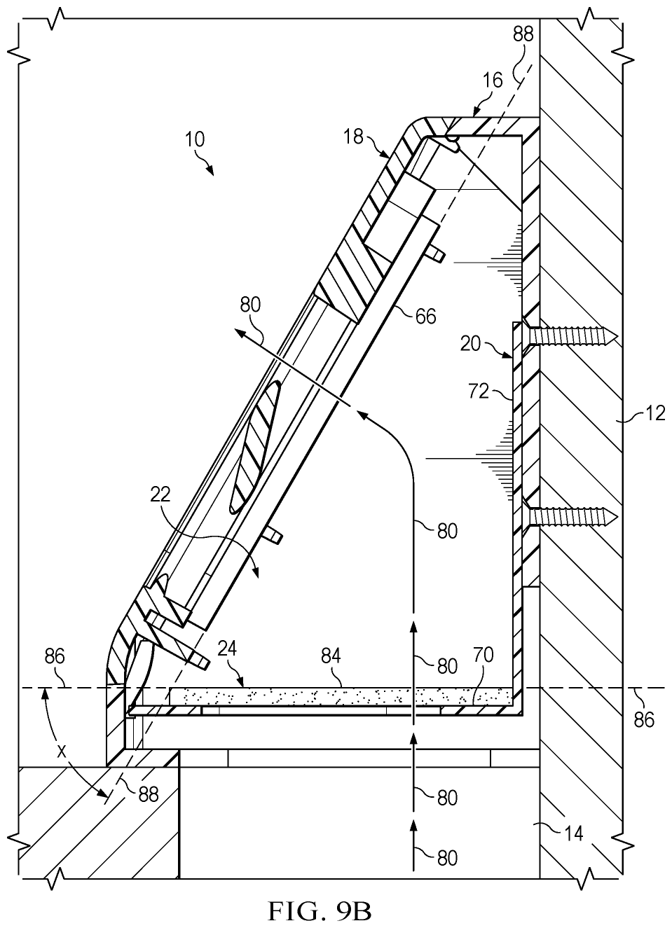

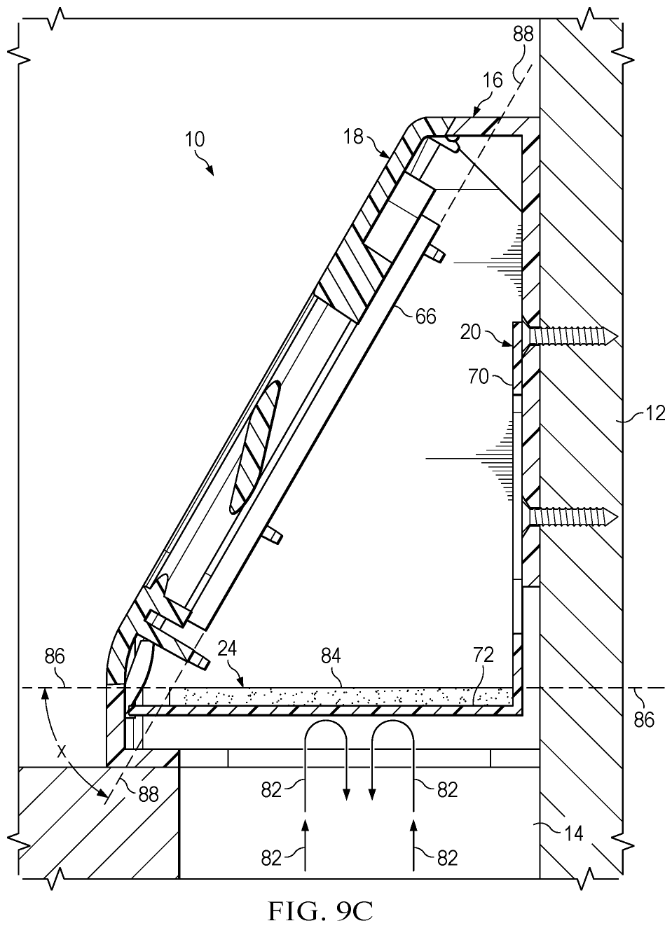

FIG. 9A depicts that the grill 18 is moveable between a first position and a second position relative to vent housing body 16. To install the grill 18 on the body 16, the grill may be lowered as indicated by arrow 76 to connect hinge flange 60 with hinge notch 62. The hinged connection enables the grill 18 to pivot about a longitudinal pivot axis as indicated by arrow 78. This pivoting action of grill 18 allows the grill to open (i.e., a first position) and close (i.e., a second position).

FIG. 9B and FIG. 9C depict that the dual-mode filter support 20 may comprise or be utilized in two modes. Namely, there is a first mode of the dual-mode filter support 20 (arranged as shown in FIG. 9B), wherein the first mode permits air to flow through the aperture 74 in the first leg 70 of the elongated L-shaped member. FIG. 9B depicts that the first mode permits airflow, represented by arrows 80, can move from the duct 14 through the apertures 74 in the first leg 70 of support 20, through the filter 24, and out through the grill 18.

There is a second mode of the dual-mode filter support 20, wherein the second mode blocks or impedes air from flowing through the air passageway 22 (arranged as shown in FIG. 9C). FIG. 9C depicts that the second mode inhibits or impedes airflow, represented by arrows 82, such that the solid second leg 72 of support 20 blocks air movement to effectively “close” the vent register such that airflow 82 substantially does not leave duct 14.

The dual-mode filter support 20 is selectively moveable between the first mode and the second mode. The dual-mode filter support 20 is selectively moved between the first mode and the second mode through an inversion action (i.e., flipping the dual-mode filter support) when the grill 18 is hinged open relative to the vent housing body 16. Alternatively, the dual-mode filter support 20 is selectively moved between the first mode and the second mode through a rotational action (i.e., rotating the dual-mode filter support about a longitudinal axis, a vertical axis, or both) when the grill 18 is hinged open relative to the vent housing body 16.

The dual-mode filter support 20 is inserted and disposed within the vent housing body 16. When the dual-mode filter support 20 is within the vent housing body 16, the dual-mode filter support 20 contacts or is otherwise supported by the first lip 50 on the first sidewall 46 and the second lip 52 on the second sidewall 58. Additionally, the support 20 may contact or be supported by the front lip 54. The dual-mode filter support 20 contacts the first lip 50 and the second lip 52 in both the first mode and the second mode.

The filter 24 is supported and selectively placed upon the dual-mode filter support 20. When the dual-mode filter support 20 is in the first mode, the filter 24 is positioned above the first leg 70 in the air passageway 11 such that air moves through the aperture 74 in the first leg 70, through the filter 24, and through the air passageway 22. The filter 44 includes a first major surface 84 of the filter, wherein the first major surface 84 lies along a first plane 86. When the dual-mode filter support 20 is in the first mode, the first plane 86 is parallel to the first leg 70 of the elongated L-shaped body 68 of filter support 20 and the first plane 86 is perpendicular to the second leg 72 of the elongated L-shaped body 68 of filter support 20. When the dual-mode filter support 20 is in the second mode, the first plane 86 is parallel to the second leg 72 of the elongated L-shaped body 68 of filter support 20 and the first plane 86 is perpendicular to the first leg 70 of the elongated L-shaped body 68 of filter support 20. Alternatively, when the dual-mode filter support 20 is in the second mode, the filter 24 may be removed from apparatus 10 and stored for later usage. The rear surface 66 of the grill 18 lies along a second plane 88. The first plane 86 and the second plane 88 are not parallel to each other as what was previously taught in U.S. Pat. No. 6,942,710. To the contrary, the first plane 86 associated with the major surface 84 of the filter 24 and the second plane 88 associated with the rear surface 66 of the grill 18 define an angle X therebetween, wherein the angle X between the first and second planes 86, 88 ranges from about 10 degrees to about 80degrees. In one particular embodiment, the angle X ranges from about 30 degrees to about 60 degrees. In one particular embodiment, angle X is about 30 degrees.

Filter 24 may comprise a filtering substrate with a spray-on antimicrobial coating. One exemplary filter substrate is commercially known as POLYSORB form Duraflow Industries. The substrate may be sprayed with an antimicrobial coating to result in a filter 24 with an antimicrobial disinfectant. One exemplary spray-on coating is the Pro-Tech Antimicrobial Disinfectant. Another exemplary filter with antimicrobial coating is taught in U.S. Pat. No. 7,942,957.

The apparatus 10, device, assembly, or system of the present disclosure may additionally include one or more sensor to sense or gather data pertaining to the surrounding environment or operation of the apparatus 10, device, assembly, or system. Some exemplary sensors capable of being electronically coupled with the apparatus 10, device, assembly, or system of the present disclosure (either directly connected to the apparatus 10, device, assembly, or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; Temperature sensors sensing machine or motor temperature, ambient air temperature, and environmental temperature; and Moisture Sensors sensing surrounding moisture levels.

The apparatus 10, device, assembly, or system of the present disclosure may include wireless communication logic coupled to sensors on the device, assembly, or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wifi, ZigBee, MiWi, Bluetooth) for communication. In one example, each of the devices, assemblies, or systems of the present disclosure may have its own IP address and may communicate directly with a router or gateway. This would typically be the case if the communication protocol is WiFi. For example, a signal may be generated by a sensor or other scheduled-based manner to send a WiFi communication pertaining the filter's useful life or need for replacement.

The system that receives and processes signals from the device, assembly, or system of the present disclosure may differ from embodiment to embodiment. In one embodiment, alerts and signals from the device, assembly, or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department or a homeowner. Thus, if a particular device, assembly, or system of the present disclosure creates an alert because of a data point gathered by one or more sensors, that alert can be sent, in e-mail or SMS form, directly to the individual responsible for fixing it or replacing the filter. Of course, e-mail and SMS are only two examples of communication methods that may be used; in other embodiments, different forms of communication may be used.

In other embodiments, alerts and other data from the sensors on the device or apparatus 10, assembly, or system of the present disclosure may also be sent to a work tracking system that allows the individual, or the organization for which he or she works, to track the status of the various alerts that are received, to schedule particular workers to repair a particular device, assembly, or system of the present disclosure, and to track the status of those repair jobs or when the filter needs replaced. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the device, assembly, or system of the present disclosure, and the system may be able to provide aggregate machine operational data for a device, assembly, or system of the present disclosure or group of devices, assemblies, or systems of the present disclosure.

As described herein, aspects of the present disclosure may include one or more secondary components and/or systems therein. The apparatus 10 of the present disclosure is therefore contemplated and will be understood to include any necessary operational components thereof. For example, it will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A filtered air vent apparatus comprising:
a vent housing body comprising a first sidewall and a second sidewall defining a portion of an air passageway that extends between at least a first open end and a second open end;
a grill hingedly attachable to the vent housing body and securable to the vent housing body;
a dual-mode filter support sized to fit within the vent housing body in the air passageway; and
a filter that is selectively and removably positioned on the dual-mode filter support in the air passageway and behind the grill.

2. The filtered air vent apparatus of claim 1, wherein the dual-mode filter support comprises:
a body formed as a monolithic unibody elongated L-shaped member.

3. The filtered air vent apparatus of claim 1, wherein the dual-mode filter support comprises:
a body configured as an elongated L-shaped member.

4. The filtered air vent apparatus of claim 3, wherein the dual-mode filter support further comprises:
a first leg of the L-shaped elongated member, wherein at least one aperture is formed in the first leg; and
a second leg of the elongated L-shaped member, wherein the second leg is solid.

5. The filtered air vent apparatus of claim 4, wherein the dual-mode filter support further comprises:
a first mode of the dual-mode filter support, wherein the first mode permits air to flow through the aperture in the first leg of the elongated L-shaped member;
a second mode of the dual-mode filter support, wherein the second mode impedes air from flowing through the air passageway;
wherein the dual-mode filter support is selectively moveable between the first mode and the second mode.

6. The filtered air vent apparatus of claim 5, wherein the dual-mode filter support further comprises:
a first lip on the first sidewall of the vent housing body;
a second lip on the second sidewall of the vent housing body;
wherein the dual-mode filter support is contacts the first lip and the second lip in both the first mode and the second mode.

7. The filtered air vent apparatus of claim 5, wherein the dual-mode filter support is selectively moved between the first mode and the second mode through an inversion action when the grill is hinged open relative to the vent housing body.

8. The filtered air vent apparatus of claim 5, wherein the dual-mode filter support is selectively moved between the first mode and the second mode through a rotational action when the grill is hinged open relative to the vent housing body.

9. The filtered air vent apparatus of claim 5, wherein when the dual-mode filter support is in the first mode, the filter is positioned above the first leg in the air passageway such that air moves through the aperture in the first leg, through the filter, and through the air passageway.

10. The filtered air vent apparatus of claim 5, further comprising:
a first major surface of the filter, wherein the first major surface lies along a first plane;
wherein when the dual-mode filter support is in the first mode, the first plane is parallel to the first leg of the elongated L-shaped body and the first plane is perpendicular to the second leg of the elongated L-shaped body.

11. The filtered air vent apparatus of claim 5, further comprising:
a first major surface of the filter, wherein the first major surface lies along a first plane;
wherein when the dual-mode filter support is in the second mode, the first plane is parallel to the second leg of the elongated L-shaped body and the first plane is perpendicular to the first leg of the elongated L-shaped body.

12. The filtered air vent apparatus of claim 1, further comprising:
a first lip on the first sidewall of the vent housing body;
a second lip on the second sidewall of the vent housing body;
wherein the dual-mode filter support is selectively contacts the first lip and the second lip in both a first mode and a second mode.

13. The filtered air vent apparatus of claim 12, further comprising:
a lower end of the first sidewall, wherein the first lip extends in a cantilevered manner into the air passageway from the lower end of the first sidewall; and
a lower end of the second sidewall, wherein the second lip extends in a cantilevered manner into the air passageway from the lower end of the second sidewall.

14. The filtered air vent apparatus of claim 1, further comprising:
a rear surface of the grill, wherein the rear surface of the grill is spaced apart from the filter.

15. The filtered air vent apparatus of claim 14, further comprising:
a first major surface of the filter, wherein the first major surface lies along a first plane;
wherein the rear surface of the grill lies along a second plane;
wherein the first plane and the second plane are not parallel to each other.

16. A filtered air vent apparatus comprising:
a vent housing body comprising a first sidewall and a second sidewall defining a portion of an air passageway that extends between at least a first open end and a second open end, wherein the vent housing body is configured to be mounted flush with a wall of structure to align the air passageway with an air duct;
a louvered grill hingedly attachable to the vent housing body and securable to the vent housing body, and a rear surface of the grill;
a filter that is selectively and removably positioned in the air passageway and behind the grill, and a first major surface of the filter, wherein the first major surface lies along a first plane;
wherein the rear surface of the grill lies along a second plane; and
an angle defined the first plane and the second plane, wherein the angle defined between the first plane and the second plane is in a range from about 10 degrees to about 80 degrees.

17. A method for a filtered air vent apparatus comprising:
moving a grill from a first position to a second position relative to a vent housing body that defines an air passageway therethrough;
placing a dual-mode filter support within the vent housing body, wherein the dual mode-filter support is an elongated L-shaped member that includes a first leg, wherein at least one aperture is formed in the first leg, and includes a second leg, wherein the second leg is solid; and
moving the grill from the second position to the first position.

18. The method of claim 17, further comprising:
orienting the dual-mode filter support in a first mode with the aperture defined in the first leg to permit air to move through the air passageway; and
placing a filter on the first that air is filtered by the filter as air moves through the air passageway.

19. The method of claim 18, further comprising:
orienting the dual-mode filter support in a second mode with the second leg being solid substantially precludes air from moving through the air passageway.

20. The method of claim 19, wherein orienting the dual-mode filter support in the second mode is accomplished by rotating or inverting the dual-mode filter support.
